(19) United States
(12) Patent Application Publication
(10) Pub. No.: US 2019/0134648 A1
(43) Pub. Date: May 9, 2019

(54) DENSE MEDIUM CYCLONE SEPARATOR

(71) Applicant: COMMONWELATH SCIENTIFIC AND INDUSTRIAL RESEARCH ORGANISATION, Acton, Australian Capital Territory (AU)

(72) Inventor: Shenggen HU, Mt Ommaney, Queensland (AU)

(21) Appl. No.: 16/095,473

(22) PCT Filed: Apr. 20, 2017
(86) PCT No.: PCT/AU2017/050357

§ 371 Date: Oct. 22, 2018

(30) Foreign Application Priority Data
Apr. 22, 2016 (AU) 2016901505

(51) Int. Cl. B04C 3/06; B03B 9/00; B03B 5/34

(52) U.S. Cl. CPC B04C 3/06; B04C 2009/007; B03B 5/34; B03B 9/005

(57) ABSTRACT

A dense medium separation device for separating a mixture which comprises: an outer housing defining a central longitudinal axis, the outer housing comprising: an inlet in fluid communication with the outer housing; a vortex space inside at least the outer housing; an outlet assembly arrangement in fluid communication with the outer housing and inlet, the outlet assembly arrangement having: an outer body arranged about the central longitudinal axis; and at least one inner body having a portion arranged concentrically inside the outer body, the outer body and the at least one inner body defining therebetween at least two concentric and fluidly separated outlet passages in fluid communication with the inlet, each outlet passage including an outlet in fluid communication with the inlet; and a central rod extending along the central longitudinal axis within at least the vortex space, the central rod configured to rotate about the central longitudinal axis, wherein when the mixture is introduced into the inlet, the central rod is rotated in the direction of vortex flow within the vortex space and rotational flow separates respective portions of the mixture into each of the at least two outlet passages.

### CROSS-REFERENCE

The present application claims priority from Australian Provisional Patent Application No. 2016901505 filed on 22 Apr. 2016, the contents of which should be understood to be incorporated into this specification by this reference.

### TECHNICAL FIELD

The present invention generally relates to a dense medium cyclone separator. The invention is particularly applicable to the separation of solids particles using dense medium cyclone separators, preferably coal particles of different specific density by their relative movement in a dense medium, such as magnetite and/or ferrosilicon, suspended in water and it will be convenient to hereinafter disclose the invention in relation to that exemplary application. However, it is to be appreciated that the invention is not limited to that application and could be used to separate a variety of different density particles from a solid particle feed.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Raw mined coal includes a certain amount of gangue mineral content which leaves a solid ash residue following combustion under standard conditions. Saleable coal typically has a fixed ash specification limit which is normally specified in contractual agreements between the coal producer and the purchaser. In many cases, raw coal is processed after mining by a dense medium separator to separate gangue mineral content and other undesirable particles and therefore provide a more saleable product.

A number of different dense medium separators can be selected for use based on the size of particles being treated. For example, large lumps may be processed in heavy medium drums, heavy medium baths, heavy medium vessels, larcodems or the like, and smaller but still coarse particles may be processed in heavy medium cyclones, heavy medium cycloids or the like. It should be understood that the terms “heavy” and “dense” can be used interchangeably in this context. These types of dense medium separator devices use a benign or inert finely ground powder of medium solids, such as magnetite and/or ferrosilicon, suspended in water to form a dense medium whose density can be controlled by the proportion of solids in the slurry. Mixing the raw coal with the dense medium enables separation on the basis of its density relative to the density of the dense medium. For example, coal with an ash level of 10% may be separable from higher ash components of the raw coal by adding the raw coal to a dense medium of, for example, 1400 kg/m³. In this example, the 10% ash product coal might float clear of the higher ash material which might tend to sink in the dense medium. The material that floats would report to the overflow outlet of a separator and that which sinks would report to the underflow outlet.

Dense medium cyclones (DMCs) are typically used as separating devices in the coal industry. DMCs have a similar geometrical structure design to hydrocyclones having a cono-cylindrical shape with either a tangential or involute feed inlet into the cylindrical section and an outlet at each end. The outlet at the cylindrical section is called the vortex finder. The second outlet at the conical end is known as the spigot. A feed dense medium, carrying the suspended particles, enters the cyclone tangentially, spirals downward and produces a centrifugal force field. Heavier particles (sink) move through the medium towards the wall of the cyclone and progresses downwards along the cyclone wall in a spiral flow pattern until exit through the spigot as DMC underflow. At the spigot, an inner vortex flow carrying most of the liquid and lighter particles (float) with it, rotating in the same direction as the outer vortex flow but flowing upward, begins to form due to the flow restriction of the spigot and leaves the cyclone through the vortex finder as DMC overflow.

Although the geometrical structure design of convention DMCs is effective for removing solids from fluids and size classification, it can be sub-optimal to the application of dense medium separation due to one or more of the following factors (explained in more detail below):

(1) excessive medium segregation;

(2) having a feed medium density lower than the separation density;

(3) the formation of a central air core in the DMC, and

(4) difficulty in directly monitoring separation density.

In conventional DMCs, a high tangential velocity and a small diameter of the inner reverse vortex flow can result in the centrifugal force acting on particles being so high that a significant amount of fine medium particles is separated from the inner vortex flow stream and captured in the stream discharged through the spigot. The density of the DMC underflow can therefore be higher than that of the feed medium, which in turn can be higher than that of the DMC overflow medium. It is often observed that the density in the DMC overflow is more than 0.5 RD higher than that in the DMC underflow. The effects of the excessive medium segregation include operation difficulty at low feed medium densities and reduced separation efficiency.

A feed medium with a density lower than 1350 kg/m³ can be unstable when processed in conventional DMCs, providing difficulties in accurately controlling particle separation at low densities. The density at which a particle would have an equal chance of reporting either to the overflow or the underflow is known as the “separation density” or the “cut point density”. As particles move in the outer spiral flow towards the spigot, the density of the medium surrounding particles increases significantly due to medium segregation. The separation density is therefore always higher than the feed medium density. This can cause problems when a low separation density is required because a feed medium with a lower density must be used. From an operational point of view, it is desirable to have a dense medium separator with a separation density lower than the feed medium density to avoid medium instability problem.

Excessive medium segregation can cause a recirculation of certain particles within a conventional DMC. When the difference between the underflow and overflow medium density is large, particles of a narrow density range around the separation density would be too lighter to be discharged from spigot and too heavy to exit from the vortex funder, leading to recirculation. When the amount of circulating material become too large for the DMC to tolerate, the DMC contents are discharged as “surge”, mainly through the spigot. The separation efficiency is poor under such circumstances.

The outlets of a conventional DMC are along its rotational axis and are open to the atmosphere. A low pressure zone created by the inner upward vortex can causes an air core to form along this axis. The air core disturbs the helical flow field due to the instability of air core and hence reduces the separation efficiency. Under conventional DMC operation, the air core is essential to the separation process. The diameter of air core decreases with an increase in the solids content of the slurry feed. When a feed slurry contains a high content of heavy particles, an air core may be unable to form due to an excessive amount of material existing through the spigot, and therefore the separation sharpness or efficiency can be significantly diminished. The presence of air core also can cause the congestion of material towards both outlets under a high rotation rate and therefore limits the use of high separation force.

It would therefore be desirable to provide an apparatus and method for the separation of solids particles of different specific density which substantially alleviates and/or overcomes the disadvantages of prior apparatuses and methods.

### SUMMARY OF THE INVENTION

The present invention provides a dense medium separation apparatus for the separation of solids particles of different specific density by their relative movement in a dense medium in response to a centrifugal force generated by the helical flow of tangentially injected slurry mixture. The configuration of separator of the present invention enables the separation characteristics of the solids particle mixture carried in a dense medium to be directly controlled, thereby allowing particle components of different specific density to be separated from a particle feed.

A first aspect of the present invention provides a dense medium separation device for separating a mixture, the device comprising:

an outer housing defining a central longitudinal axis, the outer housing comprising:

an inlet in fluid communication with the outer housing;

a vortex space inside at least the outer housing;

an outlet assembly arrangement in fluid communication with the outer housing and inlet; the outlet assembly arrangement having:

an outer body arranged about the central longitudinal axis; and

at least one inner body having a portion arranged concentrically inside the outer body, the outer body and the at least one inner body defining therebetween at least two concentric and fluidly separated outlet passages in fluid communication with the inlet, each outlet passage including an outlet in fluid communication with the inlet; and

a central rod extending along the central longitudinal axis within at least the vortex space, the central rod configured to rotate about the central longitudinal axis;

wherein when the mixture is introduced into the inlet, the central rod is rotated in the direction of vortex flow within the vortex space and rotational flow separates respective portions of the mixture into each of the at least two outlet passages.

The advantages of the present invention result from the inclusion of the rotating central rod and/or the configuration of the outlet assembly arrangement.

The rotating central rod is configured to substantially suppress, and preferably avoid the formation of an air core in the vortex flow. This minimizes turbulence in the vortex flow which would otherwise be caused by random eccentricity movement of the air core which decreases separation efficiency. The central rod also decreases mixing within vortex flow due to a reduction in hydraulic diameter.

The central rod can have any suitable configuration. In some embodiments, the central rod comprises a rotatably mounted cylinder or shaft disposed along the longitudinal axis of the outer housing. The central rod rotates around said longitudinal axis. The cylinder may be solid or hollow. In some embodiments, the diameter of the central rod has a stepped configuration, with the diameter in the outlet assembly being smaller than within the outer housing to provide more space for the easy discharge of particles in the inner outlet passage.

The central rod rotates about the longitudinal axis in the same direction as the rotation of the helical flow within the vortex space. This ensures flow resistance of the rod surface against the swirling flow stream is minimized. This rotation can be driven by a number of means. In some embodiments, the central rod is rotatably driven about the longitudinal axis by at least one of: a drive means; or friction force of the helical flow of the mixture within the vortex space. Suitable drive means include a motor, preferably an electric motor. The rotational speed can vary depending on the application and material fed in to the separator. In embodiments, the central rod is driven at a speed of from 0.0 to 200 RPM, preferably 1 to 100 RPM.

The dimensions of the central rod depend on the size of the separator, and more particularly the size of the outer housing containing the vortex space. In some embodiments, the ratio of the diameter of the central rod to the diameter of the outer housing is from 0.05 to 0.5. In other embodiments, the ratio of the diameter of the central rod to the diameter of the outer housing is from 0.1 to 0.5, preferably from 0.1 to 0.3.

Similarly, the dimensions of the outer housing can have an effect on the separation characteristics of the separator. In embodiments, the ratio of the length of the outer housing to the diameter of the outer housing is from 0.5 to 10. In other embodiments, the ratio of the length of the outer housing to the diameter of the outer housing is from 1 to 10, preferable from 1 to 8, more preferably from 1 to 5. In other embodiments, the ratio of the length of the outer housing to the diameter of the outer housing is from 3 to 10, preferably from 3 to 8, more preferably from 5 to 8.

The outlet assembly is configured so that the helical slurry flow stream containing particles is radially distributed according to particle density and is simultaneously and smoothly subdivided into two or more outlet passages under the condition of no air core movement. These conditions aim to minimize the mixing caused by flow field disturbances, and reduce if not eliminate surging phenomena which can occur with other types of cyclone separators. Advantageously, the simultaneous splitting of the flow stream can avoid remixing induced by flow field disturbance during the withdrawing of portions of flow streams at different time stages. The outlet assembly can have any number of suitable configurations to fulfil this function. In embodiments, the outlet assembly comprises a series of concentric cylindrical tubes configured to simultaneously subdivide the fluid from the vortex space. In such embodiments, each of the outlet passages (formed between the tubes) can have outlet openings concentrically arranged about the longitudinal axis X-X, and fluidly connected to the outer housing. In some embodiments, the outlet assembly forms a stepped cylindrical arrangement, with the outer body and concentric inner bodies progressively extending at different lengths along the longitudinal axis X-X from the outlet opening.

The separator can include any number of inner bodies. The number of inner bodies determines the number product streams that are cut or separated from the feed mixture. In some embodiments, the separator includes at least two inner bodies having a portion arranged concentrically inside the outer body, the respective inner bodies being concentrically arranged about the longitudinal axis, the outer body and at least two inner bodies defining therebetween at least three concentric and fluidly separated outlet passages in fluid communication with the inlet, each outlet passage including an outlet in fluid communication with the inlet. The use of three or more outlet passages therefore creates an intermediate product from the feed mixture. It should be appreciated that in embodiments, the separator includes two, three, four, five, six or more inner bodies to produce various numbers of intermediate products. The additional intermediate product can be either a second class quality product or recycled as a part of feed for repeated processing to improve the separation sharpness.

The outer body can have any desired diameter. However, it can be preferable for the outer body to have a diameter that substantially corresponds to the diameter of the outer housing. This produces a cut or product which includes the coarsest/densest particles which are forced to the outer wall. The inner bodies are concentrically arranged within the outer body about the longitudinal axis. Each of the inner bodies are sized, more preferably have diameters selected to capture a desired particle density in the helical slurry flow stream fed. Each of the inner bodies are preferably evenly spaced apart about the longitudinal axis, therefore providing an even annular gap defining the opening of each outlet passage. The outlet passages are preferably sized to capture selected particles according to particle density. In embodiments, the radial spacing of the outlet passage between the central rod and adjoining inner body is 10 to 60% of the total radial spacing between the central rod and the outer body, preferably between 10 to 50% of the total radial spacing between the central rod and the outer body. Preferably, the inner bodies are evenly spaced apart between the outer body and the inner body adjoining or closest to the central rod.

The outlets can have any suitable configuration. In some embodiments, the at least two outlets extend substantially perpendicular to the longitudinal axis. Preferably, the at least two outlets comprise perpendicularly mounted tubes. In some embodiments, the at least two outlets extend horizontal to downward relative to the longitudinal axis. Preferably, a portion of each of the outlets is tangential to a portion of the outer housing.

The inlet can have any suitable configuration. In some embodiments, at least a portion of the inlet is tangential to the outer body. Preferably, the inlet comprises at least one tangentially mounted tube.

The outer housing can have any suitable configuration. In embodiments, the outer housing comprises a hollow cylindrical body mounted horizontally on a ground engaging mounting arrangement. The outer housing is preferably stationary relative to the ground engaging mounting arrangement.

The vortex space within the outer housing comprises an area in which the feed particles enter the outer housing and flow in a vortex from the inlet through to the outlet assembly and therethrough to the respective outlet passages, depending on the density of the particles. The particles within the vortex space become radially distributed about the central rod. The vortex space typically extends at least from the inlet area to the outlet assembly arrangement. In some embodiments, the vortex space extends from the inlet to each of the outlets.

The mixture preferably comprises a dense medium mixed with the particles or solids to be separated, for example coal particles. The dense medium can comprise any desired feed mixture. In preferred embodiments the dense medium comprises a slurry formed from a mixture of fine particulate material and solids, typically a particulate material, to be suspended in water. In some embodiments, the dense medium comprises an aqueous slurry of an inert finely ground powder of solids, preferably magnetite and/or ferrosilicon. In these embodiments, the solids to be treated are mixed with a dense medium, normally aqueous suspension of finely ground magnetite and/or ferrosilicon, and this slurry mixture is fed tangentially into the separator through the inlet to the cylindrical body. A centrifugal force which acts on radially outward particles is developed by the helical flow around the central rod generated by tangentially injected slurry mixture. Under the combined actions of the centrifugal force, drag force and turbulent diffusion force, particles are separated according to their specific density. Therefore particles denser (heavier) than the dense medium are flung to the region close to the separator wall and move downwards (sink) along the wall in a spiral flow pattern until they leaves the separator through outer annuli. Particles lighter than the dense medium move inwards (float) and finally exit from the separator via the inner annuli. It should be appreciated that the density of the mixture is controlled by the proportion of fine solids in the dense medium.

The separator can be constructed in any suitable manner. In some embodiments, the separator is composed of sections, with each section including couplings adapted to provide a fluid-tight seal between the sections. For example, the separator can be formed from at least an outer housing section and an outlet assembly arrangement section. These sections can include co-operating coupling arrangements, for example flanges, which can be coupled or otherwise connected together to form a fluid-tight seal therebetween. In embodiments, the first and second outlets include couplings adapted to provide the first and second outlets with fluid tight attachments to conduits.

A second aspect of the present invention provides a method of separating a mixture of materials, the method comprising:

providing a dense medium separator according to any one of the preceding claims;

mixing solid particles to be treated with a dense medium to form a mixture;

introducing a mixture into the inlet of the separator under pressure; and

rotating the central rod of the separator in the direction of vortex flow within the vortex space,

wherein rotational flow of the mixture within the vortex space separates respective portions of the mixture into each of the at least two outlet passages.

In some embodiments, the method further comprises: preparing a feed dense medium with a required medium density; and mixing the solids particles to be treated with the feed dense medium.

In some embodiments, the method further comprises: driving rotation of the central rod around its axis by the rotation force of the helical flow or an external motor.

The goal of an effective dense medium separator operation is to control the separation density (RD50) of a dense medium separator at a specified value that will maximize the plant yield subject to a quality constraint imposed by customer's specification and/or overall plant performance. However, the RD50 of a conventional dense medium separator typically cannot be directly monitored. The RD50 of conventional dense medium separator is obtained from laboratory washability analysis or tracer test-work. The data obtained has a degree of accuracy on which the industry has based decisions about the performance level of the dense medium separator and whether corrective actions are necessary. Unfortunately, these tests are characterised by their relatively high cost and long time frame before information becomes available. Infrequent testing can result long delays before non-optimal performance of a conventional DMC is discovered and can therefore result in significant coal loss.

The present invention is therefore also intended to provide a method for directly monitoring and controlling the separation density of the separator in a particulate material processing system. In this respect, the method further comprises:

varying the density of the feed dense medium and/or the flow rate of the fluid stream flowing through the inlet opening until the medium density of the exit flow stream containing light (product) particles equal to the required the separation density. Then the actual separation density (RD50) of the separator of this invention is approximately equal to the medium density of the exit flow stream containing light (product) particles.

It should be appreciated that the separation density can be directly determined from the medium densities of flow streams that exit from the outlets. More particularly, in embodiments, the separation density is approximately equal to the medium density of the exit flow stream/outlet containing light (product) particles. This will allow the direct monitoring the separation density and promptly corrective actions, and therefore increases the separation efficiency of the separator.

The present invention has application to the separation of particulate materials, such as minerals and carbonaceous solids such as coal, iron ore, manganese, diamonds, and other materials. The present invention has particular application to the processing of coal. However, it should be understood that the invention is applicable to processing other materials including, but not restricted to, those mentioned above.

### BRIEF DESCRIPTION OF THE DRAWINGS

The present invention will now be described with reference to the figures of the accompanying drawings, which illustrate particular preferred embodiments of the present invention, wherein:

FIG. 1 provides an external view of the dense medium separator according to one embodiment of the present invention.

FIG. 2 provides a cross-sectional perspective view of the dense medium separator shown in FIG. 1 showing the internal structure thereof.

FIG. 3 shows a partition curve of fine coal (0.125 to 1.7 mm) with a particle density range of 1.2 to 2.3RD.

FIG. 4 illustrates the effect of central rod rotation on the distribution of medium density.

FIG. 5 provides a plot of coal particle density and ash value in streams at different ports (port 5 is close to the outer body wall).

### DETAILED DESCRIPTION

The present invention is intended to provide an apparatus for the separation of solids particles of different specific density by their relative movement in a dense medium in response to a centrifugal force generated by the helical flow of tangentially injected slurry mixture.

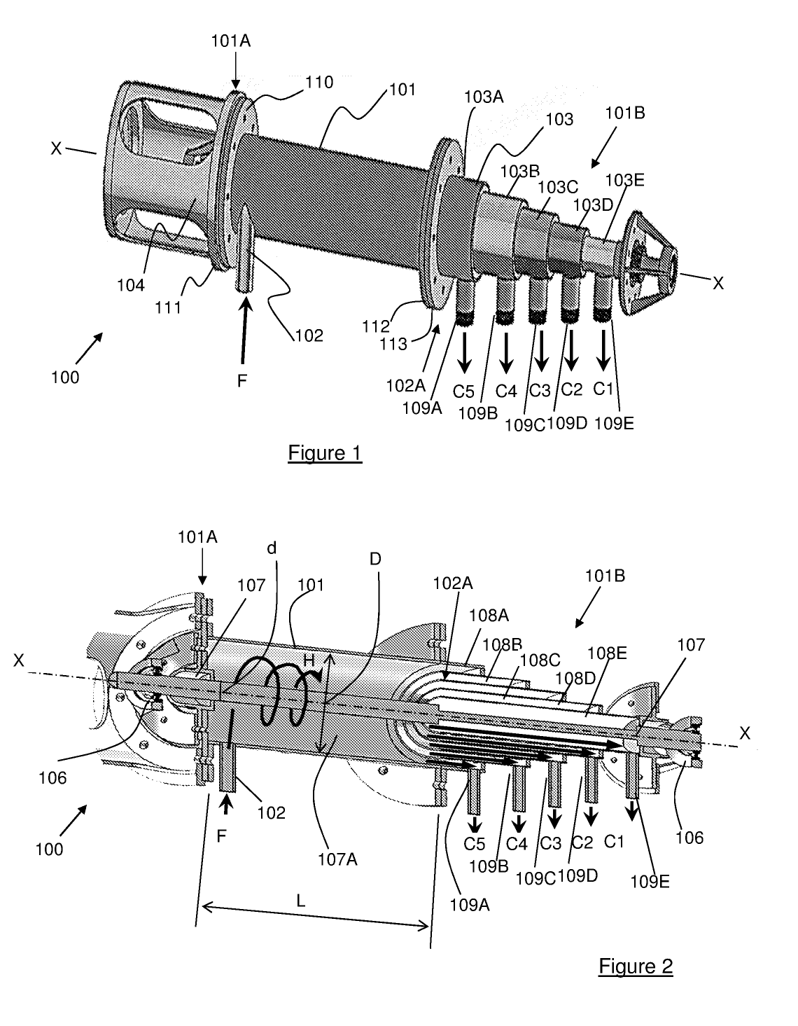

A dense medium separation separator 100 embodying one embodiment of the present invention is shown in FIGS. 1 and 2.

The illustrated separator 100 comprises an outer housing 101 comprising a hollow cylindrical body mounted horizontally on a ground engaging mounting arrangement (not illustrated). The outer housing 101 is stationary relative to the ground engaging mounting arrangement. A longitudinal axis X-X is defined longitudinally therethrough outer housing 101 along the central longitudinal axis thereof. The separator 100 is mounted with the longitudinal axis X-X nearly horizontal relative to the ground.

The outer housing 101 includes an inlet port 102 tangentially mounted on the outer housing about longitudinal axis X-X at or near one end, herein after referred to as the proximal end 101A of the separator 100. Inlet port 102 comprises a cylindrical port configured for introducing a feed fluid stream under pressure into outer housing 101. As will be explained in more detail below, the tangential orientation of inlet port 102 enables this feed fluid to be fed into the outer housing 101 in the form of a helical flow.

The outer housing 101 also includes outlet assembly 103 disposed at the exit end 101B of separator 100. The outlet assembly 103 comprises a series of concentric cylindrical tubes 103A to 103E configured to simultaneously subdividing the helical slurry flow stream fed into and flowing through the outer housing 101. As best shown in FIG. 2, the outlet assembly 103 comprises five concentric cylindrical outlet tubes 103A to 103E centred about longitudinal axis X-X and having diameters which radially spaced apart the tube walls of each outlet tubes 103A to 103E about longitudinal axis X-X. Whilst five outlet tubes are illustrated, it should be appreciated that any number of outlet tubes could be used. In preferred embodiments, the number of outlet tubes is at least two, more preferably at least three.

Each of the outlet tubes 103A to 103E have outlet openings 102A concentrically arranged about the longitudinal axis X-X, and fluidly connected to the outer housing 101. The different diameters of outlet tubes 103A to 103E are selected to capture a desired particle density in the helical slurry flow stream fed, thus providing a desired cut or particle density range. Effectively, the particles are radially distributed within the outlet tubes 103A to 103E according to particle density. The concentric arrangement of outlet tubes 103A to 103E form a series of associated concentric tube annuli 108A to 108E between the different tubes and in the case of outlet tube 103E, between that tube and central rod 105 (described in more detail below). The largest diameter outlet tube 103A has a diameter substantially corresponding to the diameter of the outer housing 101. The smaller diameter outlet tube 103E is sized to provide selected diameter larger than the diameter of the cylindrical central rod 105 within the outlet assembly 103. Outlet tubes 103B to 103E therefore comprise inner cylindrical bodies within the largest diameter outlet tube 103A having differing diameters as noted above.

As shown in FIGS. 1 and 2, the outlet assembly 103 forms a stepped cylindrical arrangement, with each outlet tubes 103A to 103E extending a different lengths along the longitudinal axis X-X from the outlet opening 102A, with the smallest diameter outlet tube 103E extending the furthest along the longitudinal axis X-X from the outlet opening 102A. Each outlet tube 103A to 103E includes associated exit ports 109A to 109E comprising perpendicularly mounting tubes. The exit ports 109 are preferably oriented downwardly, horizontally or therebetween to allow the separator 100 to drain on shutdown.

The separator 100 therefore includes a vortex space 107A for the feed within the outer housing 101 and the outlet assembly 103, in which the feed particles enter the outer housing 101 and flow in a vortex (thus in a vortex flow) from the inlet port 102 through to the outlet assembly 103 and therethrough to the respective outlet ports 109A to 109E, depending on the density of the particles.

The central rod 105 is mounted longitudinally therethrough along longitudinal axis X-X and through the vortex space 107A of both the outer housing 101 and the outlet assembly 103. The central rod 105 comprises a longitudinally and rotatably mounted cylinder or shaft disposed along the axis of the outer housing which functions within the apparatus 101 to suppress, preferably prevent the formation of air core within the helical flow of particles flowing through the outer housing 101 and outlet assembly 103. In the illustrated embodiment, the central rod 105 is mounted on two bearing assemblies 106 located at each end 101A and 101B of the separator 100 which allow for the smooth rotation of the central rod 105. Two shaft seals 107 are also used to fluidly seal these end, to retain the fluid within the outer housing 101 and the outlet assembly 103. The central rod 105 is rotatably driven about longitudinal axis X-X by an external electric motor (not shown) via a coupling arrangement 104. The central rod 105 rotates around its axis in the same direction as the rotation of the helical flow (see arrow H in FIG. 2) so that the flow resistance of the rod surface against the swirling flow stream is minimized. In an alternate embodiment of the invention, the rotation of the central rod 105 can be driven by the friction force of the swirling action of the helical flow. As shown in FIG. 2, the diameter of the central rod 105 has a stepped configuration, with the diameter in the outlet assembly 103 being smaller than within the outer housing 101 to provide more space for the easy discharge of particles in the inner outlet passage.

The length L and diameter D of the outer housing 101 has an effect on the time the particles spend in the vortex flow H within the separator. For good separation, it is preferred that the ratio of the length L of the outer housing 101 to its diameter D is in the range of 0.5 to 10. Similarly, the effectiveness of the central rod 105 in suppressing and/or preventing the formation of air core within the helical flow of particles depends on the diameter d of that central rod 105 relative to diameter D of the outer housing. The ratio of the diameter d of the central rod 105 to the diameter D of the outer housing 101 is in the range of 0.05 to 0.5. Furthermore, it is preferable for the radial gap size of the inner annulus 108E is 10% to 60% of the total radial gap size between the central rod 105 surface and the outer housing 101 wall, and the remaining part of the total radial gap size is shared by the rest annuli.

In the illustrated embodiment, the outer housing 101 includes inlet flange 110 at the inlet end 101A and an outlet flange 112 at outlet end 101B. The inlet flange 110 is connectable to a top plate 111 using fasteners (not illustrated), preferably a bolt and nut arrangement. The coupler 104 for electrical motor is coaxially mounted on the top plate 111. One bearing assembly 106 is disposed at the centre of and the other is supported by the end support plate 114. Two shaft seals 107 are supported by the top plate 111 and the end support plate 114. The outlet flange 112 is connectable to a cooperating flange 113 on the outlet assembly 103 using fasteners (not illustrated), preferably a bolt and nut arrangement, to fluidly seal the outer housing 101 to the outlet assembly 103. Suitable sealing arrangements such as O-rings can be used to achieve the desired fluid tight seal between the flanges 112, 113 and 110 and top plate 111 respectively.

In use, a feed fluid stream F is feed through inlet 102 into the vortex space 107A of the separator 100. The solids in the feed fluid stream F to be treated are in a mixture with a dense medium, normally aqueous suspension of finely ground magnetite and/or ferrosilicon, and this slurry mixture. The tangential entry of the feed fluid stream F into the outer housing 101 converts the linear fluid stream flow into a helical flow around the central rod 105 as shown by the helical shaped arrow pathway H shown in FIG. 2. A centrifugal force which acts on radially outward particles is developed by the helical flow around the central rod 105 generated by tangentially injected slurry mixture. Under the combined actions of the centrifugal force, drag force and turbulent diffusion force, particles are separated according to their specific density within the vortex zone 107A. Therefore particles denser (heavier) than the dense medium are flung to the region close to the separator wall and move downwards (sink) along the wall in a spiral flow pattern until they leaves the separator 100 through outer annuli. Particles lighter than the dense medium move inwards (float) and finally exit from the separator 100 via the inner annuli.

Whilst not wishing to be limited by any one theory, the inventors consider that the presence of central rod 105 along the longitudinal axis of the outer housing 101 inhabits the formation of low pressure zone and hence the formation of an air core within the vortex flow within the vortex space 107A of the separator 100. In conventional cyclonic or vortex generating dense medium separators, an air core can be formed along the vortex rotational axis line of the separators. Even under the condition of no air input through outlets open to the atmosphere, a limited amount of air contained in the feed suspension in a diluted form or as micro bubbles still can form air core along the axis due to a low pressure zone created by the vortex flow (see for example T. Neesse, J. Dueck, “Air core formation in the hydrocyclone”, Minerals Engineering 20 (2007) 349-354). The movement of this air core is characterized by random eccentricity. This phenomenon tends to cause excess turbulence (i.e., energy loss) which adversely affects the separation efficiency. The presence of central rod 105 along the longitudinal axis of the housing 101 therefore minimizes turbulence within the vortex flow that would otherwise be caused by the random eccentricity movement of air core. The presence of the central rod 105 is also thought to reduce the hydraulic diameter of the flow field, and therefore decrease turbulence mixing within the vortex flow within the vortex space 107A of the separator 100. Overall, the central rod 105 suppresses, and more preferably prevents the formation of an unstable air core which would disturb the helical flow and hence reduce the separation efficiency. As a result of these effects, the separation efficiency of separator 100 is improved through the use of central rod 105 as compared to an equivalent separator which does not include a central rod 105.

As explained above, the swirling action of the helical flow in the space between the housing 101 and the central rod 105 produces a centrifugal force under the condition of no air core movement causing dense and/or coarse particles migrate radially outwardly towards the wall of the outer housing 101 and move downwards along that wall in a spiral flow pattern, and light and/or fine particles migrate radially inwardly towards the central rod. Particles radially distributed in the helical slurry flow stream according to particle density are then simultaneously subdivided by the outlet tubes 103A to 103A and enter the respective concentric tube annuli 108A to 108E based on their position within the helical slurry flow stream at the openings 102A. This results in dense and/or coarse particles to leave the separator through outer annuli 108A for dense cut product C5 and light and/or fine particles to exit via the inner annuli 108E for light cut product C1. The simultaneous splitting of the flow stream F can avoid the remixing induced by flow field disturbance during the withdrawing of portions of flow streams at different time stages.

It also should be appreciated that the co-current and simultaneous cutting from the outlet assembly 103 can allow all particles in the vortex zone 107A to find a flow stream having a density of surrounding medium close to their particle density. As previously explained, excessive medium segregation can cause a recirculation of certain particles in a conventional dense medium separator configuration. When the difference between the underflow and overflow medium density is large, particles of a narrow density range around the separation density would be too light to be discharged from the spigot and too heavy to exit from the vortex finder, leading to recirculation. When the amount of circulating material become too large for the dense medium separator to tolerate, the dense medium separator contents are discharged as “surge”, mainly through the spigot. The separation efficiency under such circumstances is poor.

Furthermore, prior art dense medium separators with a reverse vortex flow have the problem of flow mixing between the downward and the upward spiral flows due to turbulent diffusion. This mixing will reduce the separation sharpness. The illustrated separator 100 alleviates this problem by having simultaneous subdivision of the flow stream in the vortex space 107A into outlet tubes 103A to 103E. Particles from vortex space 107A enter the respective concentric tube annuli 108A to 108E based on their position within the helical slurry flow stream at the openings 102A.

The simultaneous subdivision of the flow stream into multiple portions provides additional intermediate particle products C2 to C4 between the dense/coarse and light/fine particle products. These are captured in intermediate annuli 108B to 108D.

For the case with coal separation, the separator 100 can be configured as a dense medium separator device which uses an inert finely ground powder of solids, such as magnetite and/or ferrosilicon, suspended in water to form a dense medium into which a coal feed can be mixed for separation. The density of the dense medium can be controlled by the proportion of solids in the slurry. Mixing the raw coal with the dense medium enables separation on the basis of its density relative to the density of the dense medium. The exact separation specification depends on the specified requirement. In a number of cases, this specification would be determined by the product required by a customer. The dense medium separator device would then be operated to provide a product that meets customer specifications. For example, coal with an ash level of 10% may be separable from higher ash components of the raw coal by adding the raw coal to a dense medium of, for example, 1400 kg/m³. In this example, the 10% ash product coal might float clear of the higher ash material which might tend to sink in the dense medium. In the illustrated separator, the intermediate product C2 to C4 can be used as a high ash product, improving the recovery yield of coal preparation plant.

The configuration of separator 100 allows the separation characteristics of the solids particle mixture carried in a dense medium to be directly controlled, thereby allowing particle components of different specific density to be separated from a particle feed. For example, in use, the separator 100 can be fed a dense medium feed that is prepared with a required medium density, the solids particles to be treated are mixed with the feed dense medium and this mixture stream is then fed into the feed inlet 102 of the separator 100 to cause the helical flow of the mixture stream in the outer housing. Rotation of the central rod 105 is driven around axis X-X by the rotation force of the helical flow or an external motor in order to inhabits the formation of low pressure zone and hence the formation of an air core within the vortex flow within the vortex space 107A of the separator 100. The vortex flow is then separated into separate cuts C1 to C5 in the concentric annuli 108A to 108E of outlet assembly 103, thereby discharging multiple exit flow streams separately, each of cuts C1 to C5 having different densities corresponding to the diameter of outlet tubes 103A to 103E. It is noted that the required separation density can be achieved by varying factors including the density of the feed dense medium and the flow rate of the fluid stream flowing through the inlet opening. These factors can be varied until the medium density of the exit flow stream containing light particles equal to the required separation density.

### EXAMPLES

### Example 1—Separation Characteristics

A separator 100 configured as shown in FIGS. 1 and 2 was used to separate a coal feed slurry comprising fine coal with a size range of 0.125 to 1.7 mm and a particle density range of 1.2 to 2.3 Relative Density. The outer housing 101 of the separator 100 had a diameter of 100 mm and a cylinder length of 600 mm. As illustrated in FIGS. 1 and 2, the separator 100 had five concentric tube annuli or outlet passages comprising two passages 108D and 108E close to the central rod 105 for the requisite coal product and other three 108A to C for the ash reject. The slurry feed flowrate is 60 L/min and the feed medium density was 1.46 Relative Density (RD).

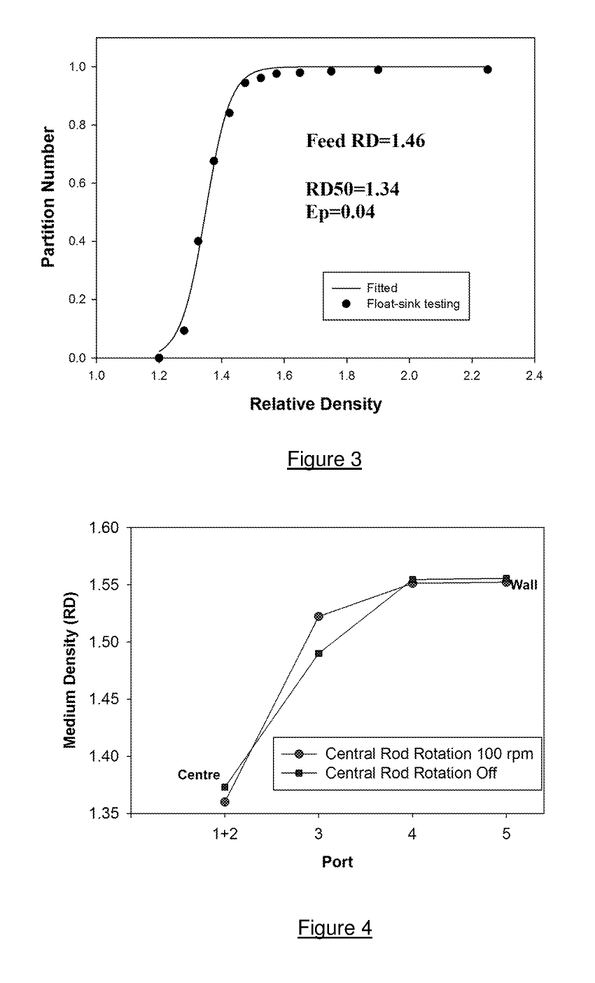

FIG. 3 is a diagram which illustrates an example of the partition curve of the separator 100. The separation density (RD50) and the separation efficiency (Ep) were calculated from the partition curve. The Ep value of 0.04 indicates that the separation efficiency of the separator is better than those obtained from dense medium cyclone for fine coal and other separation technologies for fine coal. The inventors consider that the combination of a reduction in turbulence and mixing by the use of a central rod and the concentric tube annulus outlets is attributed to the improvement in the efficiency of separation.

### Example 2

A number of tests were carried out on the dense medium separator described in Example 1 using fine coal with a size range of 0.125 to 1.7 mm and a particle density range of 1.2 to 2.3 Relative Density and 2 mm density tracers.

Table 1 shows the comparison of feed medium density, the medium density of the exit flow stream containing light (product) particles and separation density (RD50) obtained from these tests.

TABLE 1
Medium density and separation density (RD50) for tests using the separator

| | Fine | Tracer | Tracer | Tracer | Tracer | Tracer | Tracer |
|---|---|---|---|---|---|---|---|
| | Coal | Run #4 | Run #5 | Run #7 | Run #8 | Run #9 | Run #10 |
| Feed RD | 1.46 | 1.53 | 1.50 | 1.40 | 1.45 | 1.39 | 1.46 |
| Medium RD in stream | 1.35 | 1.40 | 1.38 | 1.31 | 1.40 | 1.30 | 1.37 |
| for light particles | | | | | | | |
| RD50 | 1.34 | 1.39 | 1.36 | 1.31 | 1.39 | 1.30 | 1.38 |

It can be observed that the separation density (RD50) is approximately equal to the medium density of the exit flow stream containing light (product) particles and the difference between the two densities is within the measurement error range of ±0.02RD. This relationship suggests that the medium density of the exit flow stream containing light particles can be used as a direct indicator of the separation density. This close relationship was not found when the central rod is not used. The inventors therefore propose that both the central rod and the concentric tube annulus outlets play important roles in the determination of this relationship. As a result of being able to directly control the separation density without using time-consuming float-sin or tracer test, it is believed that efficiency of separation is increased.

It is also observed in Table 1 that the density (Feed RD) of feed medium is higher than the separation density (RD50) in the separator of this invention. This relationship provides an important advantage in the practical dense medium separation process as the use of relatively high density of feed medium will improve the medium stability particularly in a separation process requiring a low separation density.

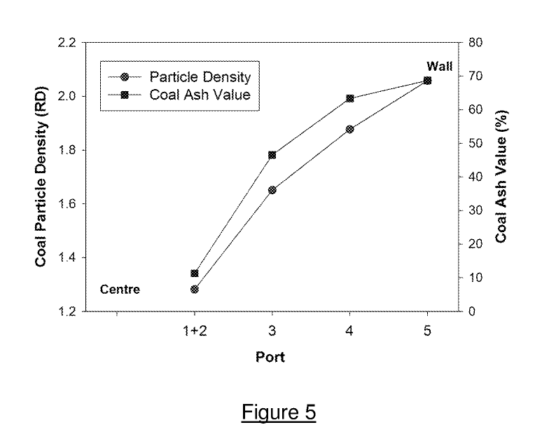

FIG. 4 shows the effect of central rod rotation on the distribution of medium density with the separator at different outlet ports 109A (port 5 in FIG. 5—close to the outer body wall) to 109E (port 1 in FIG. 5). As shown in FIG. 4, the medium density has a sharp increase from the port 2 to port 3 when the central rod is rotating. This sharp increase is beneficial to the separation sharpness.

FIG. 5 provides a plot of coal particle density and ash value in streams at different outlet ports 109A (port 5 in FIG. 5—close to the outer body wall) to 109E (port 1 in FIG. 5). FIG. 5 shows that coal particles are fractioned along the radial direction according to their density and ash value.

Those skilled in the art will appreciate that the invention described herein is susceptible to variations and modifications other than those specifically described. It is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

1. A dense medium separation device for separating a mixture, the device comprising:
an outer housing defining a central longitudinal axis, the outer housing comprising:
an inlet in fluid communication with the outer housing;
a vortex space inside at least the outer housing;
an outlet assembly arrangement in fluid communication with the outer housing and inlet, the outlet assembly arrangement having:
an outer body arranged about the central longitudinal axis; and
at least one inner body having a portion arranged concentrically inside the outer body, the outer body and the at least one inner body defining therebetween at least two concentric and fluidly separated outlet passages in fluid communication with the inlet, each outlet passage including an outlet in fluid communication with the inlet; and
a central rod extending along the central longitudinal axis within at least the vortex space, the central rod configured to rotate about the central longitudinal axis,
wherein when the mixture is introduced into the inlet, the central rod is rotated in the direction of vortex flow within the vortex space and rotational flow separates respective portions of the mixture into each of the at least two outlet passages.

2. A dense medium separation device according to claim 1, wherein the central rod comprises a rotatably mounted cylinder or shaft disposed along the longitudinal axis of the outer housing.

3. A dense medium separation device according to claim 1, wherein the central rod is rotatably driven about the longitudinal axis by at least one of: a drive means; or friction force of the helical flow of the mixture within the vortex space.

4. A dense medium separation device according to claim 1, wherein the central rod rotates about the longitudinal axis in the same direction as the rotation of the helical flow within the vortex space.

5. A dense medium separation device according to claim 1, wherein the central rod is driven at a speed of from 0.0 to 200 RPM, preferably 1 to 100 RPM.

6. A dense medium separation device according to claim 1, wherein the diameter of the central rod has a stepped configuration, the central rod having a smaller diameter in the outlet assembly compared to the diameter of the central rod in the outer housing.

7. A dense medium separation device according to claim 1, wherein the ratio of the diameter of the central rod to the diameter of the outer housing is from 0.05 to 0.5.

8. A dense medium separation device according to claim 1, wherein the ratio of the length of the outer housing to the diameter of the outer housing is from 0.5 to 10.

9. A dense medium separation device according to claim 1, wherein the outlet assembly comprises a series of concentric cylindrical tubes configured to simultaneously subdivide the fluid from the vortex space.

10. A dense medium separation device according to claim 1, wherein each of the outlet passages have outlet openings concentrically arranged about the longitudinal axis, and fluidly connected to the outer housing.

11. A dense medium separation device according to claim 1, comprising at least two inner bodies having a portion arranged concentrically inside the outer body, the respective inner bodies being concentrically arranged about the longitudinal axis, the outer body and at least two inner bodies defining therebetween at least three concentric and fluidly separated outlet passages in fluid communication with the inlet, each outlet passage including an outlet in fluid communication with the inlet.

12. A dense medium separation device according to claim 1, wherein the radial spacing of the outlet passage between the central rod and adjoining inner body is 10 to 60% of the total radial spacing between the central rod and the outer body.

13. A dense medium separation device according to claim 1, wherein the diameters of inner bodies are selected to capture a desired particle density in the helical slurry flow stream fed.

14. (canceled)

15. A dense medium separation device according to claim 1, wherein the outlet assembly forms a stepped cylindrical arrangement, with the outer body and concentric inner bodies progressively extending at different lengths along the longitudinal axis from the outlet opening.

16. A dense medium separation device according to claim 1, wherein the at least two outlets extend substantially perpendicular to the longitudinal axis

17. A dense medium separation device according to claim 1, wherein the at least two outlets extend horizontally or downwardly relative to the longitudinal axis.

18. A dense medium separation device according to claim 1, wherein a portion of each of the outlets is tangential to a portion of the outer housing.

19. A dense medium separation device according to claim 1, wherein at least a portion of the inlet is tangential to the outer body.

20. A dense medium separation device according to claim 1, wherein the outer housing comprises a hollow cylindrical body mounted horizontally on a ground engaging mounting arrangement.

21. (canceled)

22. (canceled)

23. A method of separating a mixture of materials, the method comprising:
providing a dense medium separator according to any one of the preceding claims; and
mixing solid particles to be treated with a dense medium to form a mixture;
introducing the mixture into the inlet of the separator; and
rotating the central rod of the separator in the direction of vortex flow within the vortex space,
wherein rotational flow of the mixture within the vortex space separates respective portions of the mixture into each of the at least two outlet passages.

24. (canceled)

25. (canceled)

26. (canceled)
